(19) United States
(12) Patent Application Publication
(10) Pub. No.: US 2015/0088585 A1
(43) Pub. Date: Mar. 26, 2015

(54) SUPPLY CHAIN MANAGEMENT USING PROBLEM AND REMEDIATION PROPAGATION MODELING

(71) Applicant: International Business Machines Corporation, Armonk, NY (US)

(72) Inventors: AARON DANIEL CIVIL, Rochester, MN (US); Simeao Hilario Joao, Gaithersburg, MD (US); Jeffrey G. Komatsu, Kasson, MN (US); Sathishkumar Selvaraju, Rochester, MN (US); Emmanuel Yashchin, Yorktown Heights, NY (US)

(73) Assignee: International Business Machines Corporation, Armonk, NY (US)

(21) Appl. No.: 14/037,542

(22) Filed: Sep. 26, 2013

(51) Int. Cl. G06Q 10/06

(52) U.S. Cl. CPC G06Q 10/06315
USPC 705/7.25

(57) ABSTRACT

A system, and computer program product for problem remediation in supply chain management are provided in the illustrative embodiments. A determination is made whether a data in a data stream of a supply chain process is indicative of a problem in the supply chain. Responsive to determining that the data is indicative of the problem, a confidence level is assigned to a diagnosis of the problem. Using a historical data repository, a symptom of the problem is identified. The symptom identifies a point in the data stream where the problem is manifested. Using the historical database, a remedy for the problem is identified. The remedy is recorded in the historical data repository with the problem and the symptom at a previous time. The previous time is before receiving the data stream. The remedy is applied to the supply chain.

### TECHNICAL FIELD

The present invention relates generally to a method, system, and computer program product for improving a supply chain process. More particularly, the present invention relates to a method, system, and computer program product for supply chain management using problem and remediation propagation modeling.

### BACKGROUND

Supply Chain Management (SCM) encompasses the planning and management of all activities involved in sourcing and procurement, conversion, and all logistics management activities. SCM also includes coordination and collaboration with channel partners, which can be suppliers, intermediaries, third-party service providers, and customers.

SCM integrates supply and demand management within and across companies. SCM is an integrating function with primary responsibility for linking major business functions and business processes within and across companies into a cohesive and efficient business model.

SCM includes the logistics management activities and manufacturing operations, and coordinates processes and activities with and across marketing, sales, product design, finance, and information technology.

A typical supply chain spans numerous different entities, and involves flow of significant volume and types of products in a systematic and timely manner. A change in the supply chain can have rippling effects downstream as well as upstream from the change. The change can also trigger effects in seemingly unrelated parts of the supply chain. This is true whether the change is a result of a problem condition encountered in the supply chain, an intentionally introduced element in the supply change, or a combination thereof. Guaranteeing acceptable conditions in the operation of a supply chain can be a complex task.

### SUMMARY

The illustrative embodiments provide a method, system, and computer program product for supply chain management using problem and remediation propagation modeling. An embodiment determines, using a processor and a memory, whether a data in a data stream of a supply chain process is indicative of a problem in the supply chain. The embodiment assigns, responsive to determining that the data is indicative of the problem, a confidence level to a diagnosis of the problem. The embodiment identifies, using a historical data repository, a symptom of the problem, wherein the symptom identifies a point in the data stream where the problem is manifested. The embodiment identifies, using the historical database, a remedy for the problem, wherein the remedy is recorded in the historical data repository with the problem and the symptom at a previous time, wherein the previous time is before receiving the data stream. The embodiment applies the remedy to the supply chain.

Another embodiment includes computer usable code for determining, using a processor and a memory, whether a data in a data stream of a supply chain process is indicative of a problem in the supply chain. The embodiment further includes computer usable code for assigning, responsive to determining that the data is indicative of the problem, a confidence level to a diagnosis of the problem. The embodiment further includes computer usable code for identifying, using a historical data repository, a symptom of the problem, wherein the symptom identifies a point in the data stream where the problem is manifested. The embodiment further includes computer usable code for identifying, using the historical database, a remedy for the problem, wherein the remedy is recorded in the historical data repository with the problem and the symptom at a previous time, wherein the previous time is before receiving the data stream. The embodiment further includes computer usable code for applying the remedy to the supply chain.

Another embodiment includes a storage device including a storage medium, wherein the storage device stores computer usable program code. The embodiment further includes a processor, wherein the processor executes the computer usable program code. The embodiment further includes computer usable code for determining, using a processor and a memory, whether a data in a data stream of a supply chain process is indicative of a problem in the supply chain. The embodiment further includes computer usable code for assigning, responsive to determining that the data is indicative of the problem, a confidence level to a diagnosis of the problem. The embodiment further includes computer usable code for identifying, using a historical data repository, a symptom of the problem, wherein the symptom identifies a point in the data stream where the problem is manifested. The embodiment further includes computer usable code for identifying, using the historical database, a remedy for the problem, wherein the remedy is recorded in the historical data repository with the problem and the symptom at a previous time, wherein the previous time is before receiving the data stream. The embodiment further includes computer usable code for applying the remedy to the supply chain.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an application for supply chain management using problem and remediation propagation modeling in accordance with an illustrative embodiment;

FIG. 4A depicts a block diagram of the problem detection function in accordance with an illustrative embodiment;

FIG. 4B, this figure depicts an example evidence curve used in problem detection in accordance with an illustrative embodiment;

FIG. 5 depicts a block diagram of the remediation function in accordance with an illustrative embodiment;

FIG. 6 depicts a block diagram of a propagation modeling function in accordance with an illustrative embodiment;

FIG. 7 depicts a flowchart of an example process of supply chain management using problem and remediation propagation modeling in accordance with an illustrative embodiment; and

FIG. 8 depicts a flowchart of an example sub-process of supply chain management using problem and remediation propagation modeling in accordance with an illustrative embodiment.

### DETAILED DESCRIPTION

In today's highly competitive supply chain oriented business, statistical process control is a recognized method for maintaining a supply chain process on target and with low variability. Statistical process control is also recognized as a good method of detecting emerging issues or problems in a given supply chain.

The statistical process control method and other similar presently used techniques are adequate for identifying some emerging or existing supply chain process problems. However, the illustrative embodiments recognize that, these presently available techniques lack the ability to facilitate more sophisticated problem management capabilities.

For example, the illustrative embodiments recognize that the presently available techniques for SCM are unable to estimate the proportions of a population of parts that is afflicted with the problem. The population of parts in a supply chain is the product—both problematic products and good products—that exists in the supply chain at a given time.

As described above, a problem in a supply chain, such as the introduction of a defective product into the supply chain, can have rippling effect upstream, downstream, and sideways in the supply chain. As another example, the illustrative embodiments recognize that the presently available techniques for SCM are unable to measure the propagation of a defect through a population of parts.

The illustrative embodiments further recognize that when a problem is remedied in a supply chain, the presently available techniques for SCM are unable to track the how, where, and when the defect remediation has been applied in the supply chain, and which portions of a population of parts have been remedied.

The illustrative embodiments further recognize that when a problem is remedied in a supply chain, the presently available techniques for SCM are unable to evaluate the effectiveness of remediation. The illustrative embodiments recognize that the presently used techniques are unable to provide active feedback on the effectiveness of remediation. Active feedback is the process of monitoring and detecting the effects of a change, such as a change caused by the introduction of a remedy into the supply chain, and using those effects to adjust the remedy during the operation of the supply chain.

The illustrative embodiments further recognize that the presently available techniques for SCM are unable to compare emerging trends in the supply chain, such as an indication of a possible problem, with a historical record of previous trends. Thus the illustrative embodiments recognize that the presently available techniques result in an inability to formulate hypotheses about the type, scope, and effect of a potential problem in the supply chain.

The illustrative embodiments further recognize that an unsatisfied need exists for creating and managing a historical database of known problems and the results of various remediation strategies. The illustrative embodiments further recognize a need for enriching the historical database with current observations of problems and remedial actions in the supply chain.

Presently, SCM systems use traditional methods such as yield, trend, performance versus target, and other statistical methods for problem detection in a piecemeal way. When a single measure is used at a time, as is presently the case, evidence garnered by one technique is often excluded by, ignored by, or is unavailable for use by users of another technique. The illustrative embodiments recognize that even when such evidence is available, users of multiple techniques have no systematic means of cross referencing the evidence from other methods to create a detailed view of the defect in its lifecycle.

The illustrative embodiments recognize that this lack of synergy prevents quality control processes and practitioners from tracking the propagation of a defect throughout a part population, and from making early determinations whether defect remediation is having the desired effect. Additionally, the illustrative embodiments recognize that existing mechanisms are unable to provide timely and continuous feedback on the direction of movement in defect trending.

The illustrative embodiments recognize that together, these inabilities result in lost time and resources that are unnecessarily dedicated to pursue defect resolution. Because of these deficiencies, quality control organizations and processes are less able to react appropriately, resulting in lost time, revenue, and customer satisfaction.

The illustrative embodiments used to describe the invention generally address and solve the above-described problems and other problems related to SCM. The illustrative embodiments provide a method, system, and computer program product for supply chain management using problem and remediation propagation modeling.

A defective product introduced into a supply chain, and a process defect in the supply chain are collectively referred to as a problem or a defect herein. Using an embodiment, a synergistic view of the data stream from a supply chain allows practitioners and owners of quality control processes the ability to make better informed decisions. For example, an embodiment determines whether a defect is propagating through a population. An embodiment further determines whether a defect remediation strategy is working in a desired manner.

An embodiment further determines whether a change is suitable or sufficient to remedy the defect. An embodiment can be used to determine a timing of a remediation effort, such as whether to implement the remediation effort on existing inventory in the supply chain. An embodiment also determines whether the remediation is effective on the problem being experienced in the supply chain, and whether the remedy should be reviewed, improved, or replaced by another remedy.

An embodiment allows an SCM to efficiently detect and quickly recover from adverse quality conditions in the supply chain. An embodiment discovers defect trend behaviors and remediation promulgation and effectiveness. An embodiment further provides a feedback from applying a remedy to gain an insight on the efficacy, magnitude, and trajectory of the remedy. An embodiment allows changing the remediation strategies that might better fit the current conditions in the supply chain.

A database of historical defects and remediation techniques according to an embodiment enables quicker response as compared to presently available techniques, when new problems are detected. Using an embodiment, a user can compare new defect trends against previously encountered defect trends, enabling repeated hypothesis testing and feedback about the behavior of a defect trend. An embodiment enables a user to evaluate the effectiveness of a remediation action and measure the propagation of remediation changes through a population of parts.

The illustrative embodiments are described with respect to certain methodologies, defects, data processing systems, environments, components, and applications only as examples. Any specific manifestations of such artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

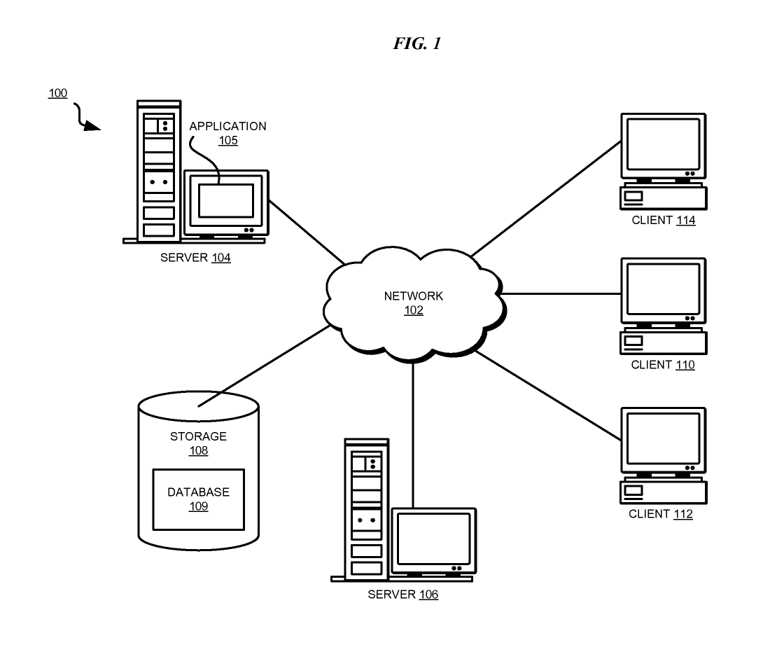

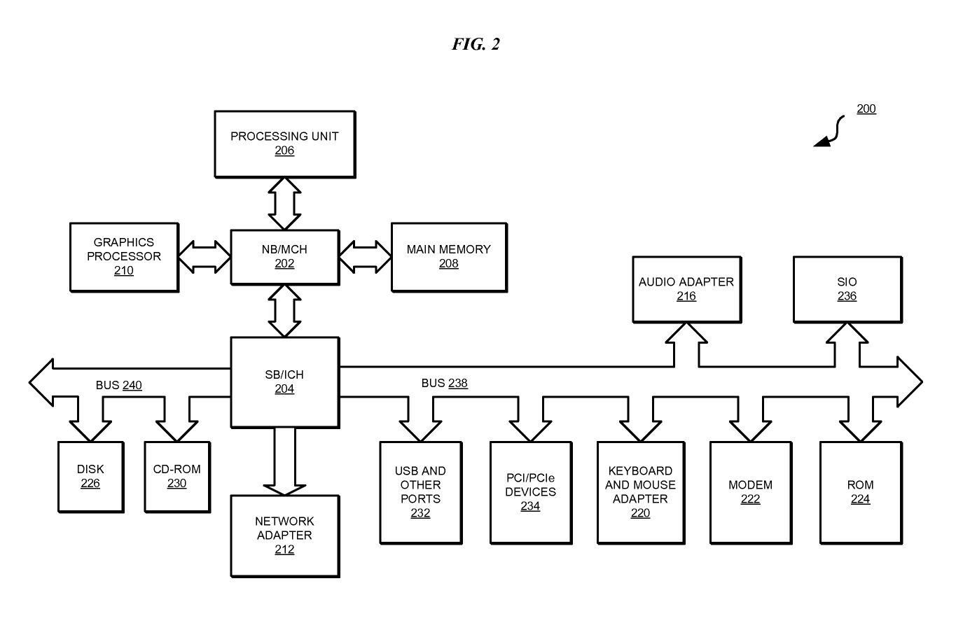

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are useable in an embodiment. Application 115 implements an embodiment described herein. Database 109 is a database of historical problems and remedies and can be updated or enriched with present experiences of problems and remedies in the supply chain. Among other things, historical database 109 includes information sufficient o diagnose an observed problem in a supply chain, resolve the symptoms to one or more problems, identify remedies used in the past for those problems, and degree of success achieved in the past by using those remedies on those problems. Database 109 can be a data repository in any form of implementation, including but not limited to relational databases, flat files, index files, and the like.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 115 and browser 117 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

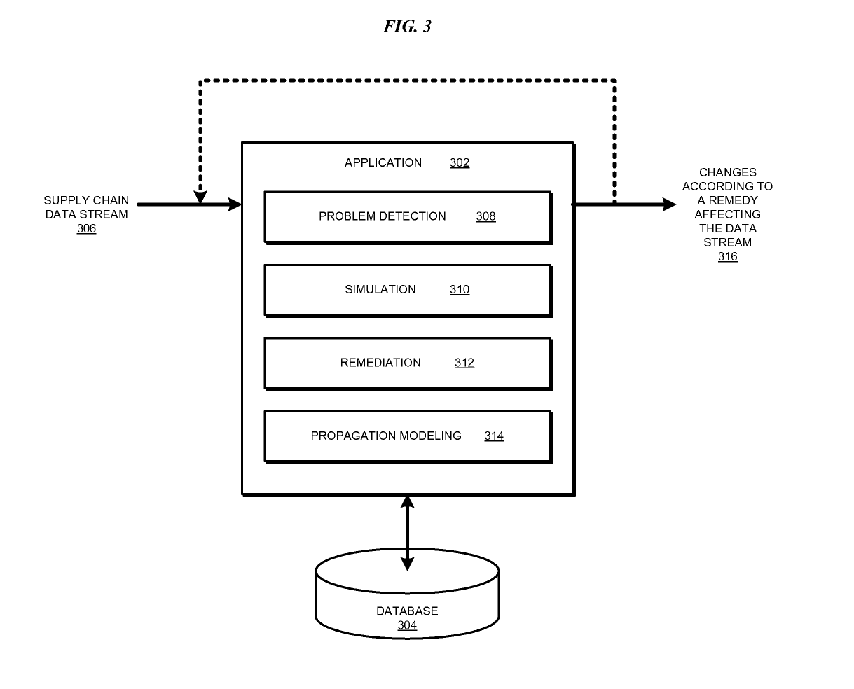

With reference to FIG. 3, this figure depicts a block diagram of an application for supply chain management using problem and remediation propagation modeling in accordance with an illustrative embodiment. Application 302 can be implemented as application 105 in FIG. 1. Database 304 can be implemented as database 109 in FIG. 1.

Application 302 receives data stream 306 from an operating supply chain. For example, systems collecting performance data, inventory data, logistics data, and other data routinely collected in an SCM at different points in the supply chain can form data stream 306.

Application performs four broad functions. Function 308 is a problem detection function that detects problems in the supply chain from monitoring data stream 306. The operation of function 308 will become cleared in the description below.

Simulation function 310 simulates a healthy, problem-free operation of the given supply chain. Function 310 generates a data stream from the simulated healthy supply chain. Application 302 uses the simulated data stream to compare with data stream 306. Such comparison is useful in cases when the actual supply chain exhibits anomalies but data in data stream 306 does not reflect the anomalies in a predictable manner or in known ways. The comparison of the simulated data stream and data stream 306 allows application 302 to detect data points in data stream 306 that deviate (deviant data) from the corresponding data points in the simulated data stream.

Function 312 is a remediation function that remedies the problems detected in the supply chain by problem detection function 308 or from a simulation by simulation function 310. The operation of function 312 will become cleared in the description below.

Function 314 performs propagation analysis of the problems and remedies in the parts population. Function 314 uses one or more propagation models that are configured for a given supply chain of a given geometry. The propagation models allow function 314 to determine how a problem, and a remedy, affects parts in the supply chain and portions of the supply chain processes as they progress through the supply chain. One way of envisioning a propagation model is to envision a container filled with water, having some movement in the water. A propagation model describes how a drop of ink (or a neutralizer of the ink) spreads in the water due to the movement of the water at a given time in a given location in the container. Techniques to create a propagation model of product movement in a supply chain are known in the prior art.

Database 304 aids function 308 in detecting a problem in data stream 306 by providing historical records of data anomalies in data stream 306. For example, if deviant data has been observed in relation to a known problem in the past according to database 304, and a similar deviant data is present in data stream 306, function 308 considers the deviant data an indicator of the same problem in the present state of the supply chain.

Database 304 aids function 312 in remedying a problem detected by function 308 or 310, by providing historical records of remedies previously applied to the same or similar problems. Database 304 not only provides historical information to application 302 but also receives diagnostic information, problem identification information, remedy selection, and remediation effects from application 302 to enrich database 304 for future use.

Application 302 produces changes according to a remedy selected for addressing a detected problem. The changes affect data stream 306. Application 302 continues to observe the changes in data stream 306 in a feedback loop.

The feedback of the changes data stream 306 informs application 302 whether a selected remedy is having a desired effect, of a desired magnitude, in the desired locations in the supply chain, and in the desired population of parts. Application 302 uses the feedback mechanism to adjust the problem detection, remedy selection, or both. For example, when a remedy does not appear to be having a desired effect, the cause can be not only an incorrect remedy but also an incorrect problem diagnosis or remedy application. The feedback mechanism of continuous monitoring of changes in data stream 306 allows application to make the necessary adjustments to achieve a desired level of problem remediation in the supply chain.

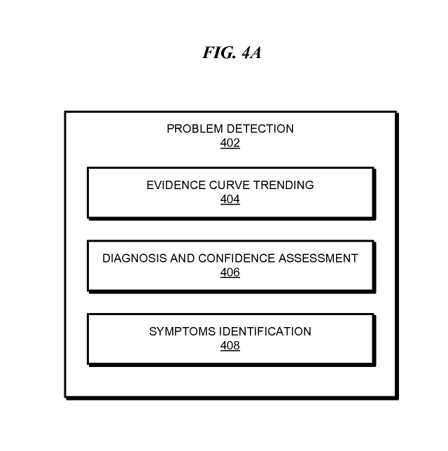

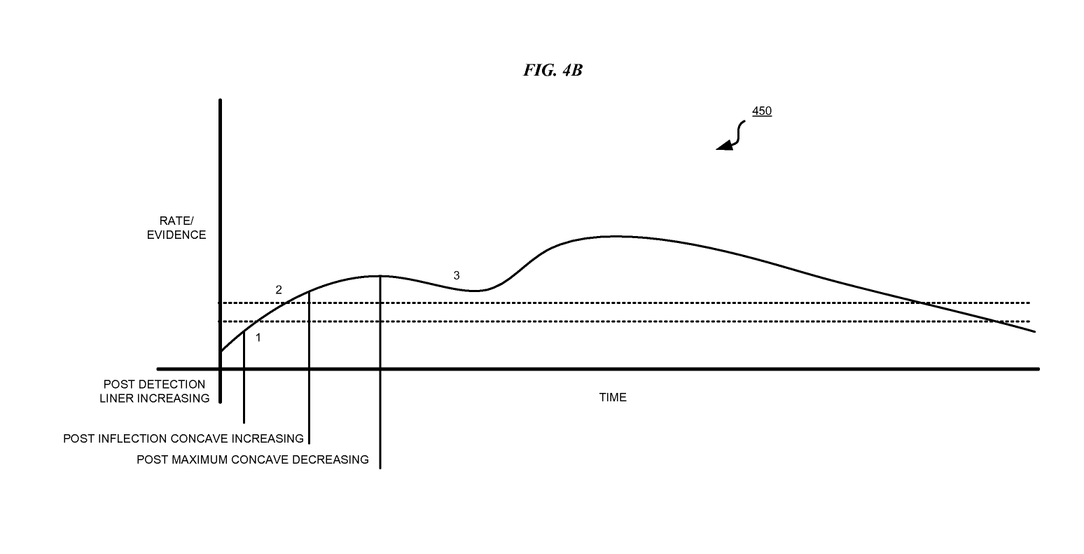

With reference to FIG. 4A, this figure depicts a block diagram of the problem detection function in accordance with an illustrative embodiment. Problem detection function 402 can be implemented as function 308 in FIG. 3.

Problem detection function 402 includes component 404. Component 404 uses one or more evidence curves to detect a problem in the data stream of a supply chain, such as in data stream 306 in FIG. 3.

The dataset of historical process control data stream, of which many may be viewed as continuous curves (evidence curves), which are obtained via standard mathematical methods of transformation of scatter plots to smooth curves [for example, a cubic spine]. An evidence curve describes conditions of a particular process parameter that trends up when parameter levels become unacceptable, and trends down when the parameter levels are acceptable.

An embodiment uses historical data, such as data stored in database 304 in FIG. 3, to create a collection of possible descriptors for a process control data stream in the form of an evidence curve (curve). These descriptors enable hypothesis testing of a new evidence curve's actual behavior based upon a historical framework of similar events.

The evidence curves are comprised of three critical moments: troughs, crests, and inflection points. An embodiment examines portions of the evidence curve that exhibit positive slope, and contain the first statistically relevant points indicative of negative process control trends. A negative process control trend is an event, such as a problem, in the supply chain that requires attention. As with typical process control evidence curves, an upward slope will necessarily have inflection points in which the curve will begin to transition from an upward trajectory to a cresting trajectory.

The historical dataset of data stream will contain critical points of interest to quality control practitioners that can be used in the analysis of the new curve. For example, some points on the evidence curve indicate an onset of a problem. These are points that occur at the initiation of problem detection curve and are the first signals that an out of control condition may exist in the data stream, and consequently in the supply chain.

Some points on the evidence curve are detection points. These points differ from the points that indicate an onset of a problem in that they are the actual points on the curve in which an embodiment had determined an out of control condition. Furthermore, at the detection points a threshold degree of confidence that a suspected problem likely exists is met or exceeded, or the slope of the curve shows an above-threshold variance. Detection points may also be hypothetical points on an evidence curve based upon simulated data.

Some points on the evidence curve are remediation points. These points on the curve occur where a remediation strategy has been applied. The remediation points enable analysis of the efficacy of a remediation technique. Whether a remediation technique is effective in solving the problem identified by the curve is indicated by subsequent points on the curve, which will respond either positively, neutrally, or negatively to a remediation.

In creating the set of descriptors for historical curves, an embodiment also creates a collection of diagnostic data about the detected problem. Diagnostic information comprises a description of the symptoms, a comprehensive description of the problem and its causes, the remediation strategy applied, and the remedy's effectiveness in alleviating the problem.

Finally, these historical data are collected for each discrete part in the data set, and are collated to create a repository of evidence curves, such as in database 304 in FIG. 3, for analysis of future data stream as they arrive.

Evidence curve trending component 404 uses these evidence curves to determine whether a problem corresponding to an evidence curve can be identified in the data stream of the supply chain. If a parameter in the data stream shows a behavior modeled in the evidence curve, component 406 performs a diagnosis and confidence assessment of the problem. For example, component 406 diagnoses how the data in the data stream supports the identification of that problem. In one embodiment, rules or heuristics are used to identify suspect data that is different that it should be, for example, out of an expected set of bounds for that data or approaching a bound at a rate different from an expected rate.

Component 406 assigns a confidence level to the diagnosed problem by considering the degree of aberration of the suspect data. As described earlier, a upward trend in an evidence curve is indicative of an onset of a problem, and contributes to the diagnosis and confidence assessment.

A supply chain's data stream is monitored for a known set of problem, each problem in the set having a corresponding evidence curve. For example, an evidence curve measures variation in a parameter and the slope of the evidence curve is therefore indicative of the degree of significance of a particular problem that causes that parameter to vary from a norm. The curve crossing a threshold indicates a significance level of the problem that needs a control action. When an evidence curve begins to creep, evidence of that problem accumulates.

In one embodiment, an evidence curve approaching a threshold may only warrant monitoring but no remedial action. The embodiment recognizes crossing a threshold as an indication of a need for a remedy.

The evidence curves correspond to known problems, and data creep may indicate a new problem that has previously not been seen in the supply chain. When all evidence curves show that the data stream data is in the normal range but some data in the data stream still appears to be deviant, an embodiment uses a simulation, such as using function 310 in FIG. 3, to identify a previously unknown problem.

In some cases, even though there may be deviant data in a data stream coming in from a supply chain, the problem detection function 402 may decide not to flag a problem condition in the supply chain, just yet. For example, just one or a small number of data points deviating from their respective norms may not comprise a sufficient evidence of a problem. As another example, an amount of the deviation in a data point may not be sufficient to flag a problem condition.

When such conditions for a judgment call arise, in one embodiment, component 406 uses rules to determine the next course of action. For example, component 406 may trigger a simulation where the deviant data is extrapolated to detect a future problems. As another example, component 406 may trigger a simulation of a normal supply chain to compare whether the deviant data warrants a problem detection or is an innocuous aberration.

Furthermore, not all problems require intervention. If a problem is detected, component 406 further determines whether the problem warrants a remedy. For example, some problems are temporary and work themselves out over time in the supply chain without requiring a remedial action. Even if a problem is identified, if component 406 cannot assign a confidence level greater than a threshold level of confidence, an embodiment deems the problem as not a negative process control event, to with, not a problem that requires intervention.

Once a problem has been identified and a confidence level assessed, component 408 performs symptom identification. Symptom identification is a process of identifying the causes of the deviant data that caused the problem to be identified.

Component 408 identifies symptoms by identifying the points in the data stream at which the problem is reflected. For example, component 408 identifies the points in the data stream where abnormal fall-out rates are observed at certain testing points, or certain failure codes are observed. For example, in one embodiment, component 408 performs a lookup in database 304 of FIG. 3, and performs a comparative study of data points in the historical data and in the data stream to determine whether the symptoms have been observed in the historical data. For example, if the historical data includes similar error codes or similar fall-out rates, a symptom of the present problem has been observed in the past, indicating that the problem has been observed in the past, and further indicating that a possible remedy may have been tried in the past and may be recorded in the database.

With reference to FIG. 4B, this figure depicts an example evidence curve used in problem detection in accordance with an illustrative embodiment. Component 404 in FIG. 4A can use evidence curve 450.

An embodiment, such as an embodiment implemented in application 302 in FIG. 3, references evidence curve 450, which is based on historical data from a historical database, such as database 304 in FIG. 3. Evidence curve 450 is a simplified evidence curve that shows how the supply chain is behaving, with both defects and remediation in “early onset” phase of the defect lifecycle, marked as regions 1 and 2 in curve 450.

The data analyzed by an embodiment has one or more characteristics. For example, one characteristic of data is that data is temporal. That is, data is generated in some fashion along an interval of time, for example, during a six month manufacturing period for a part that travels through the supply chain.

Another example characteristic of data is that data results from actual physical events, such as manufacturing, testing, packaging, shipment, etc. Another characteristic of data is that data is compiled into workable units of measure, which are collected at specified intervals, for example, hourly, daily, or weekly.

The volumes of work units, for example, the manufactured parts or assemblies, are dynamic. It is possible that a “part” is processed in multiple batches of manufacturing, testing, packaging, shipment, etc., each called a vintage. A part may, for example, be manufactured in a batch of 100 units one week, and 300 the next. Defects in the supply chain may not necessarily affect all vintages, or affect them with the same degree of adversity.

An embodiment employs remediation techniques to some vintages and not others. For example, some vintages may require re-work, while others may have to be scrapped.

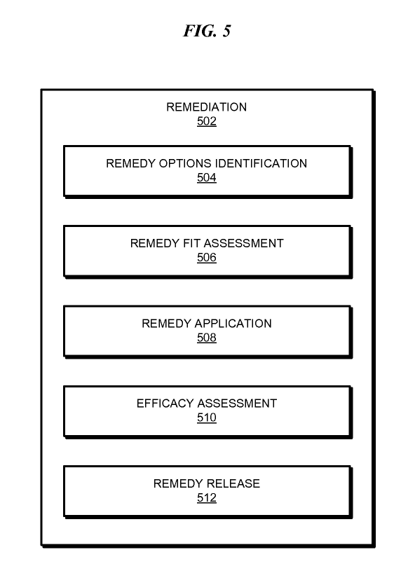

With reference to FIG. 5, this figure depicts a block diagram of the remediation function in accordance with an illustrative embodiment. Remediation function 502 can be implemented as function 310 in FIG. 3.

Based on the symptom identification performed by component 408 in FIG. 4A, component 504 performs remedy options identification using a historical database, such as database 304 in FIG. 3. Depending on the data available in the historical database, component 504 may find one or more possible remedies for a detected, diagnosed, confidence-assessed, symptom-analyzed problem. On the other hand, it is also likely that component 504 may not find any previously used remedies for the problem, such as when the problem is new and has not been observed before in the supply chain.

Component 506 performs a fit assessment of the remedies identified as possible remedial options by component 504. For example, in one embodiment, when one or more previously used remedies have been identified, component 506 prioritizes those known remedies according to the effect each remedy is known to have on the problem symptoms being seen. In another embodiment, such as when a known remedy is not found for the problem being seen in the data, component 506 uses a checklist or another scientific method for remedying the previously unknown problem. Component 506 selects the remedy that best fits the problem, such as by being the most effective on the symptoms of the problem.

Component 508 applies the best-fit remedy identified by component 506. Component 510 assesses the efficacy of the remedy upon application.

For example, component 508 applies the best-fit remedy and component 510 determines whether the remedy has been effective on alleviating or reducing the symptoms of the problem. In terms of an evidence curve, when the remedy is applied to the supply chain, component 510 determines whether, and to what degree, the feedback in the changed data stream reflect a reduction in the deviation of the deviant data.

In other words, component 510 determines how the evidence chart of the problem is trending upon application of the remedy. For example, one embodiment employs sequential probability ratio test (SPRT) methodology for the efficacy assessment. A brief description of the SPRT methodology is as follows

A feature of SPRT methodology is that the number of observations required depends on the outcome of the observations, and is not pre-determined, by a random variable. Such a feature is useful in determination the success of a remediation effort at any stage because the decision depends uniquely on the results of the observations previously made.

The Sequential Probability Ratio Test (SPRT) is a type of statistical test for which the number of observations required depends on the information accrued in the course of the test; this number is thus not pre-determined, but is a random variable. Such feature enables an embodiment to decide on the remediation success, at any stage because the decision depends uniquely on the observations previously made. As a comparison with a fixed-sample test, the SPRT frequently results in substantial savings in the number of observation.

Suppose a random sample x (sample) has a probability distribution f(x,θ). Let x=(x₁, x₂, . . . , xₙ) be a random sample used to classify treatments as effective or non-effective. Let θ=θ₀ represent an effective treatment and θ=θ₁ represent an alternative, non-effective treatment.

Let Lₙ=Product (for i=1 to n) f(xᵢ,θ₁)/f(xᵢ,θ₀),

$${L}_{n} = {\prod }_{i = 1}^{n} \frac{{f}_{i} ( {x}_{i} , {θ}_{1} )}{{f}_{i} ( {x}_{i} , {θ}_{0} )}$$

Where Lₙ is the ratio of probability (or density) of the observed results given θ=θ₁ and the probability (or density) of observed results given θ=θ₀.

In an embodiment, the SPPT plays a role in deciding the effectiveness of the remediation. The SPRT method, of testing a hypothesis H may be described as follows—A decision on the remediation success is of the following type: (1) Accept the hypothesis H₀ that the remediation is successful, (2) Accept H₁ that the remediation is not successful (and thus a new remediation technique should be applied and/or the current remediation should be stopped,) (3) Declare that the results are inconclusive and additional testing is required (i.e., continue testing). Thus, such test procedure is carried out sequentially, and continues until (1) or (2) is decided. The number n of observations required by such a test procedure is a random variable, since the value of n depends on the outcome of the observations.

Hypothesis

H0: θ=θ₀ The treatment is effective

H1: θ=θ₁ The treatment is ineffective

An embodiment stops sampling and decides in favor of θ₀ as soon as Lₙ<B; and stops sampling in favor θ₁ when Lₙ>A. When Lₙ is between A and B, an embodiment continues sampling.

The constants A and B are to be determined so as to achieve low errors (η, β) where η=Probability of deciding in favor of H₀ when H₁ is true, β=Probability of deciding in favor of H₁ when H₀ is true.

If an embodiment determines that the efficacy of a selected remedy is acceptable, such as when the efficacy meets or exceeds an efficacy threshold, component 512 releases the remedy into the supply chain. For example, component 512 may close an action item on the problem, deem the application of the remedy successful and the problem remedied, or roll-out the remedy for general deployment. For example, until the release by component 512, the remedy may be tested in a limited area or portion of the supply chain, or even on a simulation of the problem.

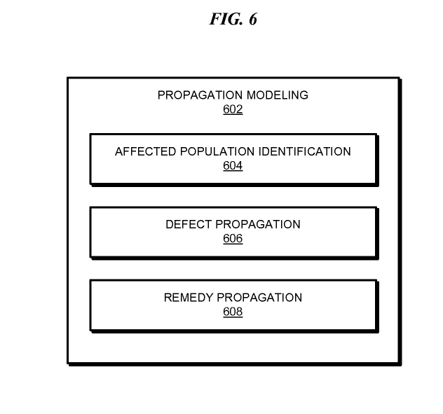

With reference to FIG. 6, this figure depicts a block diagram of a propagation modeling function in accordance with an illustrative embodiment. Propagation modeling function 602 can be implemented as function 314 in FIG. 3.

Component 604 identifies that portion of the parts population that is affected by an identified problem. Defect propagation component 606 measures the effects of a problem or a defect in the supply chain as a whole. For example, in one embodiment, component 606 measures the effects of the problem on the downstream side of the supply chain. In another embodiment, component 606 measures the effect in all directions from the locus of the problem in the supply chain. In one embodiment, component 606 identifies the parts that are affected by the problem and parts that remain unaffected by the problem.

In a similar manner, remedy propagation component 608 measures the effects of a remedy that is applied in the supply chain, such as by component 508 in FIG. 5. For example, in one embodiment, component 608 measures the effects of the remedy in all directions from the locus of the problem in the supply chain. In one embodiment, component 608 identifies the parts that are adversely affected (infected) by the remedy and parts that remain affected by the problem despite the application of the remedy.

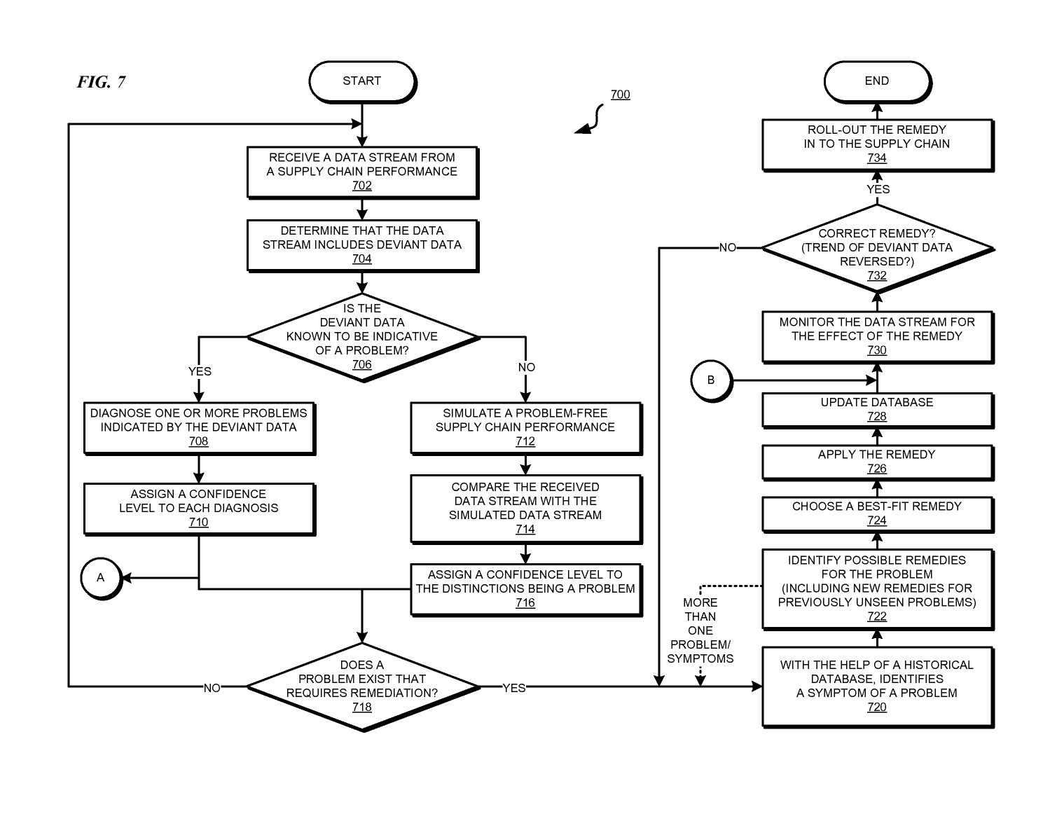

With reference to FIG. 7, this figure depicts a flowchart of an example process of supply chain management using problem and remediation propagation modeling in accordance with an illustrative embodiment. Process 700 can be implemented in application 302 in FIG. 3 using the components described in FIGS. 4A, 5, and 6.

The application begins process 700 by receiving a data stream from a supply chain during the performance of the supply chain operations (block 702). The application determines that the data stream includes deviant data (block 704).

The application determines whether the deviant data is known to be an indication of a problem (block 706). If the deviant data is known to be an indication of a problem (“Yes” path of block 706,) the application diagnoses one or more problems in the supply chain indicated by the deviant data (block 708). The application assigns a confidence level to each diagnosis (block 710).

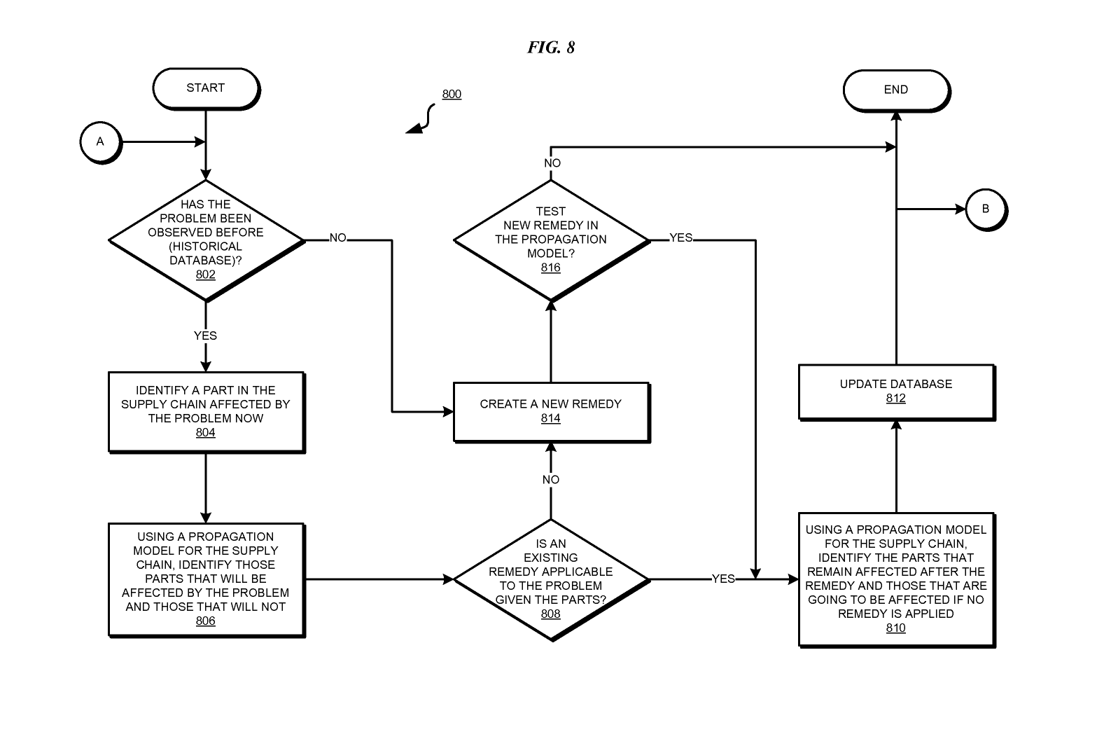

In one embodiment, the application exits process 700 at the exit point marked “A” to enter a corresponding entry point marked “A” in process 800 of FIG. 8. In another embodiment, the application proceeds to block 718 of process 700 after block 710.

If deviant data is not known to be an indication of a problem (“No” path of block 706), the application simulates a problem-free supply chain performance (block 712). The application compares the received data stream with the simulated data stream (block 714). The application assigns a confidence level to the determination that any distinction between the two data streams is an indication of one or more new and previously unknown problems (block 716).

The application determines whether the one or more new or known problems that have been identified require remediation (block 718). If no remediation is required (“No” path of block 718), the application returns to block 702 of process 700 and continues monitoring and receiving the data stream.

If remediation is needed (“Yes” path of block 718), the application, with the help of a historical database, identifies a symptom of a problem (block 720). The application identifies one or more possible remedies for the problem based on the symptom, including new remedies for previously unseen problems (block 722). The application repeats blocks 720-722 when more than one problems are identified, more than one symptoms of a problem are identified, or a combination thereof.

The application chooses a bet-fit remedy from the identified remedies (block 724). The application applies the chosen remedy (block 726). The application updates the historical database with information about the problems identified, the symptoms identified, and the remedies applied. The updating of the database can occur at block 726 or throughout process 700 at the relevant steps where such data is produced.

The application monitors the effects of the applied remedy in the data stream (block 730). The application determines whether the remedy applied was correct (block 732). For example, the application may determine whether a trend of the deviant data has reversed, slowed, or stopped in the data stream.

If the remedy is incorrect, such as when the deviant data remains unaffected, the reversing or slowing of the trend is at an insufficient rate, or if some other parts or processes in the supply chain become adversely affected (“No” path of block 732), the application returns to block 720. If the remedy is correct (“Yes” path of block 732,) the application rolls-out or commits the remedy (block 734). The application ends process 700 thereafter.

With reference to FIG. 8, this figure depicts a flowchart of an example sub-process of supply chain management using problem and remediation propagation modeling in accordance with an illustrative embodiment. Process 800 can be implemented in application 302 in FIG. 3 using the components described in FIGS. 4A, 5, and 6.

The application begins process 800, or enters process 800 from process 700 of FIG. 7 at entry point marked “A.” The application determines whether a problem observed in the data stream, received in block 702 in FIG. 7, has been observed before (block 802). The application makes the determination of block 802 by referencing a historical database as described elsewhere in the disclosure.

If the problem has not been observed before (“No” path of block 802), the application proceeds to block 814. If the problem has been observed before (“Yes” path of block 802), the application identifies a part in the supply chain that is affected by the presently observed problem (block 804). Using a propagation model for the supply chain, the application identifies those parts that will be affected by the problem and those parts that will not be affected by the problem (block 806).

The application determines whether an existing remedy is applicable to the problem given the affected and unaffected parts (block 808). If an existing remedy is applicable (“Yes” path of block 808), the application, using a propagation model for the supply chain identifies the parts that will remain affected after the remedy is applied and those parts that will become affected by the problem if no remedy is applied (block 810). The application updates the historical database with the affected parts information from block 806 and 810 (block 812). The application exits process 800 at exit point marked “B” to enter process 700 in FIG. 7 at a corresponding entry point marked “B” therein. The application may also end process 800 thereafter. As in process 700, updates to the database can be applied at any suitable time without limitation.

If an existing remedy is not applicable (“No” path of block 808), the application creates a new remedy (block 814). For example, in one embodiment, the application allows a user to design a remedy for the problem. The application determines whether to test the new remedy in the propagation model of the supply chain (block 816). If the new remedy is to be tested (“Yes” path of block 816), the application proceeds to block 810. If not (“No” path of block 816), the application exits process 800 at exit point marked “B” to enter process 700 in FIG. 7 at a corresponding entry point marked “B” therein. The application may also end process 800 thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for supply chain management using problem and remediation propagation modeling.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable storage medium. A computer readable storage device may be, for example, but not limited to, an electronic, magnetic, optical, electromagnetic, or semiconductor system, apparatus, or device, or any suitable combination of the foregoing. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can store a program for use by or in connection with an instruction execution system, apparatus, or device. The term “computer readable storage device,” or variations thereof, does not encompass a signal propagation media such as a copper cable, optical fiber or wireless transmission media.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1-13. (canceled)

14. A computer usable program product comprising a computer usable storage device including computer usable code for problem remediation in supply chain management, the computer usable code comprising:
computer usable code for determining, using a processor and a memory, whether a data in a data stream of a supply chain process is indicative of a problem in the supply chain;
computer usable code for assigning, responsive to determining that the data is indicative of the problem, a confidence level to a diagnosis of the problem;
computer usable code for identifying, using a historical data repository, a symptom of the problem, wherein the symptom identifies a point in the data stream where the problem is manifested;
computer usable code for identifying, using the historical database, a remedy for the problem, wherein the remedy is recorded in the historical data repository with the problem and the symptom at a previous time, wherein the previous time is before receiving the data stream; and
computer usable code for applying the remedy to the supply chain.

15. The computer usable program product of claim 14, further comprising:
computer usable code for determining that the data deviates from a defined normal range for the data; and
computer usable code for determining whether the remedy corrects the deviation by one of reducing, stopping, and reversing the deviation, wherein the applying is responsive to determining that the remedy corrects the deviation above a threshold level of correction.

16. The computer usable program product of claim 15, wherein determining whether the remedy corrects the deviation is performed using a sequential probability ratio test.

17. The computer usable program product of claim 14, wherein the confidence level is indicative of a severity of the problem, and wherein the severity of the problem corresponds to a slope of an evidence curve of a second data from the historical data repository as applied to the data.

18. The computer usable program product of claim 14, wherein the computer usable code is stored in a computer readable storage medium in a data processing system, and wherein the computer usable code is transferred over a network from a remote data processing system.

19. The computer usable program product of claim 14, wherein the computer usable code is stored in a computer readable storage medium in a server data processing system, and wherein the computer usable code is downloaded over a network to a remote data processing system for use in a computer readable storage medium associated with the remote data processing system.

20. A data processing system for problem remediation in supply chain management, the data processing system comprising:
a storage device including a storage medium, wherein the storage device stores computer usable program code; and
a processor, wherein the processor executes the computer usable program code, and wherein the computer usable program code comprises:
computer usable code for determining, using a processor and a memory, whether a data in a data stream of a supply chain process is indicative of a problem in the supply chain;
computer usable code for assigning, responsive to determining that the data is indicative of the problem, a confidence level to a diagnosis of the problem;
computer usable code for identifying, using a historical data repository, a symptom of the problem, wherein the symptom identifies a point in the data stream where the problem is manifested;
computer usable code for identifying, using the historical database, a remedy for the problem, wherein the remedy is recorded in the historical data repository with the problem and the symptom at a previous time, wherein the previous time is before receiving the data stream; and
computer usable code for applying the remedy to the supply chain.
